(19) United States
(12) Patent Application Publication
(10) Pub. No.: US 2024/0215767 A1
(43) Pub. Date: Jul. 4, 2024

(54) BLENDING SYSTEMS AND COUPLERS FOR A BLENDER

(71) Applicant: Vita-Mix Management Corporation, Olmsted Township, OH (US)

(72) Inventors: Mark J. Mayer, Sagamore Hills, OH (US); Thomas Clynne, Olmsted Township, OH (US)

(73) Assignee: Vita-Mix Management Corporation, Olmsted Township, OH (US)

(21) Appl. No.: 18/400,290

(22) Filed: Dec. 29, 2023

Related U.S. Application Data
(60) Provisional application No. 63/436,152, filed on Dec. 30, 2022.

(51) Int. Cl. A47J 43/08; A47J 43/046

(52) U.S. Cl. CPC A47J 43/085; A47J 43/0465

(57) ABSTRACT

A blender system is provided that includes a blade assembly, a blender base containing a motor and a motor shaft operatively coupled to the motor, and a coupling unit. The coupling unit includes a base coupler operatively coupled to the motor shaft and extending from the blender base, a blade shaft coupler coupled to the blade assembly, and a down-force element. The down-force element exerts a downward force on the blade shaft coupler to minimize a clearance between the base coupler and the blade shaft coupler during operation.

### CROSS-REFERENCE TO RELATED APPLICATION

The present disclosure claims the priority benefit of U.S. Provisional Patent Application Ser. No. 63/436,152, entitled “BLENDING SYSTEMS AND COUPLERS FOR A BLENDER” and filed Dec. 30, 2022, the entire contents of which is incorporated herein in its entirety.

### TECHNICAL FIELD

The present disclosure relates to a blender system, and more particularly, to a blender system with a coupling unit.

### BACKGROUND

Blenders and blender systems are often used to blend and process foodstuffs. Conventional blender systems typically include a base with a motor and a mixing container with an operable mixing blade assembly disposed therein. The mixing container may be operatively coupled to the blender base via mating components or a coupling unit. The interface between the mixing container and the blender base, specifically the coupler or coupling unit, may have a significant impact on the overall performance of the blender system. On the one hand, maintaining a clearance between mating components of the coupling unit can provide for efficient coupling and cost-effective manufacturing. On the other hand, maintaining clearance between mating components also presents disadvantages such as unwanted vibrations during blending and potential misalignment of mating components, which can lead to increased noise and deterioration of the blender system.

### SUMMARY

In one embodiment, the blender system includes a blade assembly. The blender system further includes a blender base, which contains a motor and a motor shaft operatively coupled to the motor. Additionally, the blender system includes a coupling unit that includes a base coupler operatively coupled to the motor shaft that extends from the blender base. Furthermore, the coupling unit may include a blade shaft coupler coupled to the blade assembly. Finally, the coupling unit may include a down-force element that exerts a downward force on the blade shaft coupler to minimize the clearance between the base coupler and the blade shaft coupler during operation.

In another embodiment, the coupling unit includes a base coupler that has a tapered first portion and a second portion, which is operatively coupled to a motor shaft. The coupling unit also includes a blade shaft coupler operatively coupled to a blade assembly. The blade shaft coupler includes a conical recess and has a corresponding tapered skirt shaped to receive the tapered first portion of the base coupler. In so doing, the base coupler and the blade shaft coupler interface and rotate together.

Additional features and advantages of the technology described in this disclosure will be set forth in the detailed description which follows, and in part will be readily apparent to those skilled in the art from the description or recognized by practicing the technology as described in this disclosure, including the detailed description which follows, the claims, as well as the appended drawings.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 is a front view of an illustrative blender system including a base, container, and cover in accordance with various disclosed aspects herein;

FIG. 2 is an exploded view of an illustrative embodiment of a coupling unit and a motor shaft for a blender system in accordance with various disclosed aspects herein;

FIG. 3A is a perspective view of an illustrative embodiment of a coupling unit for a blender system in accordance with various disclosed aspects herein;

FIG. 3B is a cross-sectional perspective view of an illustrative embodiment of a coupling unit for a blender system in accordance with various disclosed aspects herein;

FIG. 4A schematically depicts a front and cross-sectional view of an illustrative embodiment of a coupling unit with a snap-fit connector in an uncoupled state in accordance with various disclosed aspects herein;

FIG. 4B schematically depicts a front and cross-sectional view of an illustrative embodiment of a coupling unit with a snap-fit connector in a coupled state in accordance with various disclosed aspects herein;

FIG. 5A schematically depicts a front and cross-sectional view of an illustrative embodiment of a coupling unit with one or more magnets in an uncoupled state in accordance with various disclosed aspects herein; and

FIG. 5B schematically depicts a front and cross-sectional view of an illustrative embodiment of a coupling unit with one or more magnets in a coupled state in accordance with various disclosed aspects herein.

Reference will now be made in greater detail to various embodiments of the present disclosure, some embodiments of which are illustrated in the accompanying drawings. Whenever possible, the same reference numerals will be used throughout the drawings to refer to the same or similar parts.

### DETAILED DESCRIPTION

Blenders and blender systems are often used to blend and process foodstuffs. Conventional blenders generally include a blender base with a motor and a mixing container with an operable blade assembly disposed therein. A blender lid may be adapted to cover the mixing container. A user inserts contents within the mixing container to be mixed by the rotation of the blade assembly. The mixing container is positioned on the blender base, a user controls the operation of the motor within the base to rotate the blade assembly, and the contents are mixed therein.

In commercial kitchens, restaurants, and cafes, for example, and other businesses that make recipe-based food products, speed and accuracy in preparing food products is highly desirable. Time and precision are very important, and the time it takes from an order being placed to an order being complete, and the correctness of that order, can determine a customer's satisfaction and how many customers can be served. This may also affect profits. For blended products, as an example, workers take time to add ingredients to the mixing container based on a customer order or recipe, blend the ingredients, and then clean the containers and lids. Additionally, these businesses often prepare different orders in succession and prepare individual batches based on a singular customer orders. As a result, workers may utilize several different mixing containers and blender bases at a time, requiring the ability to efficiently attach, and remove mixing containers from blender bases.

To provide efficient mating of mixing containers to blender bases, blender systems may provide a generous clearance between coupling parts. This additional space, however, has the disadvantage of leaving room for parts to move and rattle during operation of the blender system. Increased clearance between coupled parts can lead to vibration and unwanted noise emanating from the blender. Increased clearance between coupled parts can also lead to decentering, gnashing, or misalignment of components, which can contribute to unwanted noise during operation and degradation of the blender system.

A need exists for blender systems and coupling units that facilitate efficient coupling of a container to a base. In addition, there is a need for blender systems and coupling units that provide one or more of the following: ease of attachment of a container to a base, secure attachment between the container and the base during use and operation of the blender system, efficient removal of the container from the base, reduced noise during use and operation of the blender system, minimized clearance space between the container and the base to provide a more snug fit, minimized rotational decentering and misalignment between coupled parts of the container during operation of the blender system, and the like.

Reference will now be made in detail to embodiments of the present disclosure, examples of which are illustrated in the accompanying drawings. It is to be understood that other embodiments may be utilized, and structural and functional changes may be made without departing from the scope of the present disclosure. Moreover, features of the embodiments may be combined, switched, or altered without departing from the scope of the present disclosure, e.g., features of each disclosed embodiment may be combined, switched, or replaced with features of the other disclosed embodiments. As such, the following description is presented by way of illustration and does not limit the various alternatives and modifications that may be made to the illustrated embodiments and still be within the spirit and scope of the present disclosure.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

It is noted that references to a blender, blender system, and the like, are understood to include food processor systems, inverted blender systems, single serving blender systems, and other mixing systems. Such systems generally include a blender base that may include a motor, a blade assembly, and a controller. Further, such systems may include a mixing container, a display, a memory and/or a processor. A blade assembly, a mixing container, and a blender base may removably attach. The blender system may be powered in any appropriate manner. In inverted or single serving blender systems, a mixing container may be differently configured in its attachment to a blender base. Such mixing containers may have a closed end that is generally distal from a blender base when the mixing container, blade assembly, and blender base are interlocked. A user, for example, places foodstuff in the mixing container and then attaches a blade assembly to the container. When operatively attached, the container and attached blade assembly are inverted and placed on a blender base. The blender base may then drive the blade assembly. In other blending systems, food stuff may be placed in an open end of a container that remains generally upright throughout its use. A cover may be placed over the open end and a closed end of the container may operatively attach to a blender base. An interior side of the closed end may include a blade assembly and a drive shaft thereto that mates with a drive shaft of the blender base. The blender base may then drive the blade assembly.

In embodiments, the blender systems may include any household blender and/or any type of commercial blender system, including those with covers that may encapsulate or partially encapsulate the blender. Commercial blender systems may include an overall blender system, such as a modular blender system that may include the blender along with other components, such as a cleaner, foodstuff storage device (including a refrigerator), an ice maker and/or dispenser, a foodstuff dispenser (a liquid or powder flavoring dispenser) or any other combination of such. A mixing container of any of the described embodiments may be any desired shape, such as a cup, bowl, pitcher, or the like.

Furthermore, while blending of “ingredients,” “contents,” or “foodstuffs” is described by various embodiments, it is noted that non-food stuff may be mixed or blended, such as paints, epoxies, construction material (e.g., mortar, cement, etc.), and the like. In addition, blending of ingredients may result in a blended product. Such blended products may include drinks, frozen drinks, smoothies, shakes, soups, purees, sorbets, butter (nut), dips or the like. Accordingly, such terms may be used interchangeably unless context suggests otherwise or warrants a particular distinction among such terms. Further, such terms are not intended to limit possible blended products and should be viewed as examples of possible blended products.

As used herein, the phrases “blending process,” “blending program,” and the like are used interchangeably unless context suggest otherwise or warrants a particular distinction among such terms. A blending process may comprise a series or sequence of blender settings and operations to be carried out by the blending device. In an aspect, a blending process may comprise at least one motor speed and at least one time interval for the given motor speed. For example, a blending process may comprise a series of blender motor speeds to operate the blender blade at the given speed, a series of time intervals corresponding to the given motor speeds, and other blender parameters and timing settings. The blending process may further include a ramp up speed that defines the amount of time the motor takes to reach its predetermined motor speed. The blending process may be stored on a memory and recalled by or communicated to the blending device.

A blade assembly may be attached to the mixing container and a blender base may drive the blade assembly with a motor. The parameters of the motor (e.g., speed, torque, etc.) may be constrained to limit or reduce the wear or strain on the mixing container or other components of the blender system. In other examples, the motor may be allowed to operate at different parameters and the life expectancy of the mixing container may be decreased relative to systems that limit the motor parameters.

Blade assemblies can include symmetric blades or blades that are asymmetric. For instance, a blade assembly may include two blade wings. The cutting path of each blade wing is defined by the leading edge of the blade wing. Each of the blade wings may be angled, twisted, or otherwise shaped so that the leading edges of the two blade wings are not the same. This means that the cutting path is not the same. Some other blades are upturned or angled from a center body relative a drive shaft. The metal blades are designed with specific bends and geometries to create thrust (pull material past the blade) and shear (cutting and aerating action). The location, size and angle of each bend dictates the effect the bent portion will have during blending.

Disclosed herein is a blender system. The blender system may facilitate attachment of a mixing container to a blender base via a coupling unit. The blender system may include a blender base, a coupling unit, and a mixing container, wherein a blade shaft coupler extends from an exterior surface of the base of the mixing container to operatively couple with a base coupler of the blender base. The blade shaft coupler may include helical formations or helical splines configured to engage with helical formations or helical spline of the base coupler. The coupling unit may include a tapered or conical interface. The coupling unit may include a snap-fit interface or a snap-fit connector. The coupling unit may include one or more moveable masses. The coupling unit may include magnets or electro magnets. In an embodiment, one or more elements between the mixing container and the blender base, including the blade shaft coupler, the base coupler, the cylindrical shaft, the one or more mating components, and the drive socket may be referred to as a coupling unit.

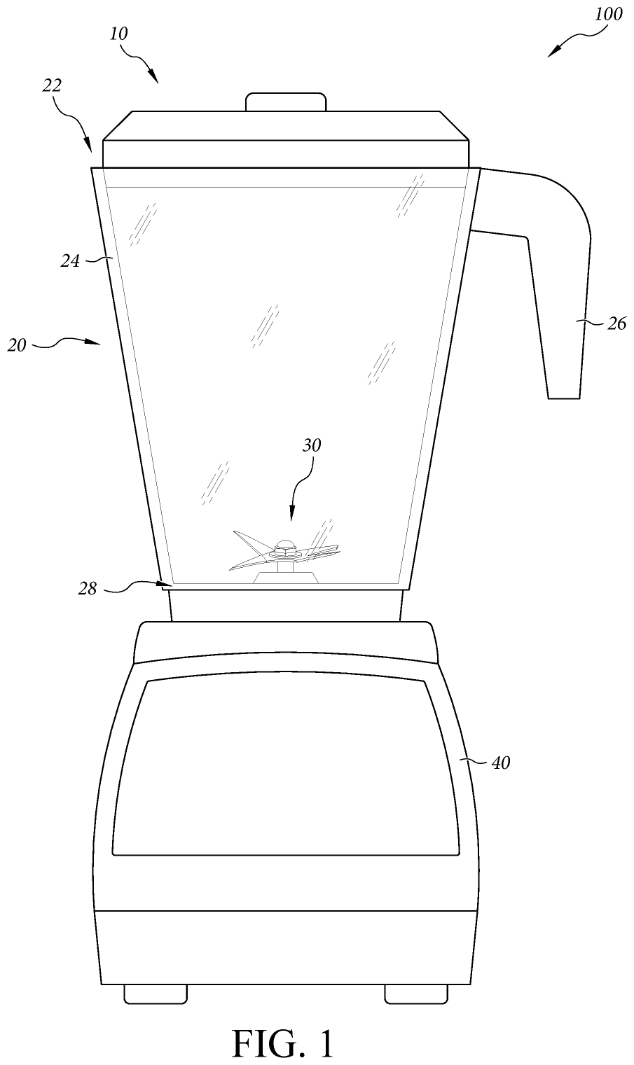

Referring now to FIG. 1, shown is a blender system 100. The blender system 100 includes a blender base 40, a mixing container 20 operatively attachable to the blender base 40, a blade assembly 30 (which may include a shield member), and a cover 10 that may be operatively attached to the mixing container 20. The mixing container 20 may include walls 24 and a handle 26. The mixing container 20 may include a first section 22, e.g., an open end, configured to operatively mate with the cover 10. The mixing container 20 may include a second section 28, e.g., a closed end configured to operatively mate with the blender base 40 on its exterior side and including the blade assembly 30 on its interior side. Foodstuff may be added to the mixing container 20 for blending. It is noted that the mixing container 20 may comprise various materials such as plastics, glass, metals, or the like.

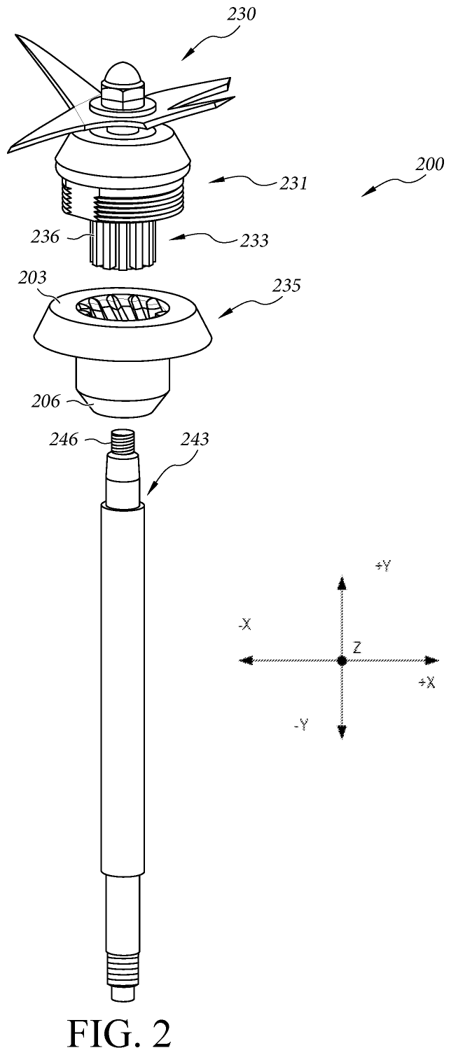

The blender base 40 may be any appropriate size and configuration to interact with the mixing container 20. The blender base 40 may house and generally protect the operative components of the blender system 100, such as a motor, a motor shaft 243 (FIG. 2), and other components (e.g., fan, controllers, circuitry, and human interfaces). The blender base 40 may include a power source (e.g., battery), a power supply unit, or may be in communication with a power source (e.g., power mains) that may power the motor and other components (e.g., a display, lighting, or the like). The motor may selectively drive the blade assembly 30 (e.g., cutting blades, chopping blades, whipping blades, spiralizing blades, etc.) via the motor shaft 243 (FIG. 2). The blade assembly 30 may agitate, impart heat, or otherwise interact with contents within the mixing container 20. The cover 10 may cover an opening of the container and enclose the contents and blended contents therein during operation of the blended system.

The blade assembly 30, mixing container 20, blender base 40, and cover 10 may removably or irremovably attach to one another. In at least one embodiment, the blender system 100 may identify or detect whether the mixing container 20 is interlocked with the blender base 40 through a magnetic detection (e.g., reed switches). A shield member may block interference with the reed switch by a magnetic field generated by the motor in accordance with various disclosed aspects.

Referring now to FIGS. 1, 2, 3A-3B, 4A-4B, and 5A-5B, the blender system 100 may further include a coupling unit 200, disclosed herein and described with reference to FIGS. 2, 3A-3B, 4A-4B, and 5A-5B, that facilitates attachment of a mixing container 20 to a blender base 40. In embodiments, the coupling unit 200 may serve to operatively connect the blade assembly 230 of a mixing container 20 to the motor shaft 243 of the blender base 40. By attaching to the blade assembly 230 and the motor shaft 243, the coupling unit 200 can enable operative attachment of the mixing container 20 to the blender base 40, allowing the motor of the blender base 40 to drive the blade assembly 230 and process foodstuff.

In an embodiment, a blender base 40 houses a motor that transfers torque to a blade assembly 230 positioned within or coupled to the mixing container 20. The mixing container 20 may be designed to be removed from the blender base 40. Thus, the coupling unit 200, positioned between the motor shaft 243 and the blade assembly 230 may allow for removal of the mixing container 20 from the blender base 40. In embodiments, the coupling unit 200 can minimize noise, vibration, and mechanical degradation by preventing the rotational decentering/misalignment of coupling components and applying a down-force to reduce clearance between the interacting portions of the coupling unit 200.

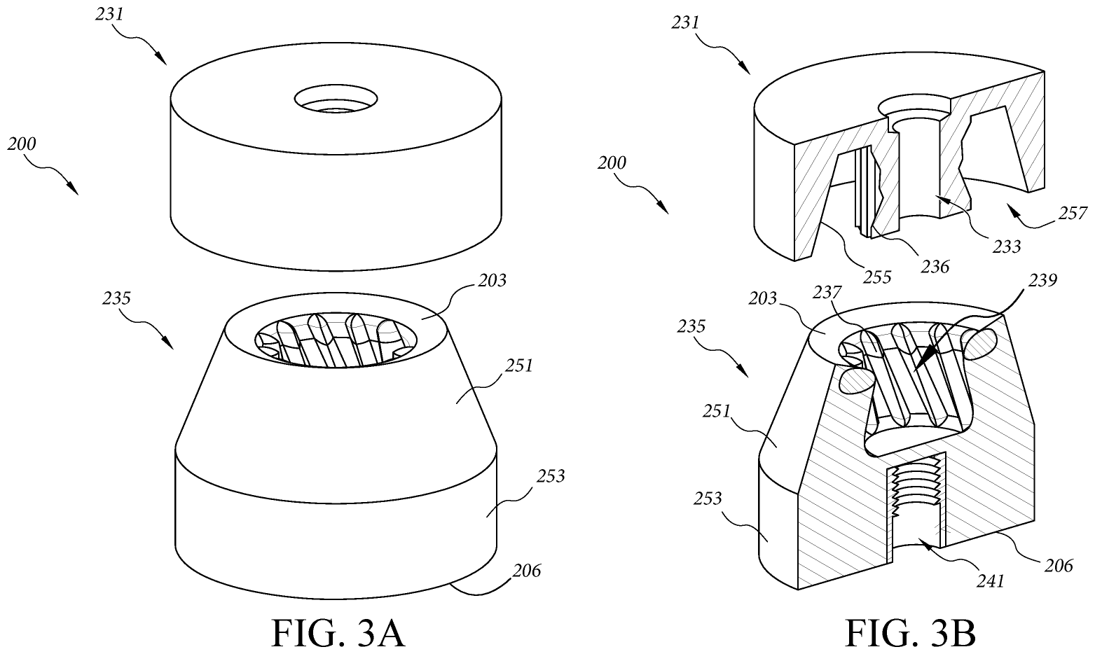

Referring specifically to FIG. 2, depicted is an embodiment of the coupling unit 200 and its respective mating components that facilitate attachment of a mixing container 20 to the blender base 40 (FIG. 1). In embodiments, the coupling unit 200 includes at least two selectively coupling components, including a base coupler 235 and a blade shaft coupler 231. The base coupler 235 may include a first side 203 and a second side 206, positioned opposite one another along the vertical axis (e.g., the +Y/−Y axis of the coordinate axes). The second side 206 of the base coupler 235 may connect to the motor shaft 243. The base coupler 235 may be removably coupled to the motor shaft 243 or it may be permanently or semi-permanently coupled to the motor shaft 243. In embodiments, the base coupler 235 has a body that defines a receptacle 241 (FIG. 3B) positioned in the center of the second side 206 of the base coupler 235. The receptacle 241 (FIG. 3B) may be a female coupler. The receptacle 241 (FIG. 3B) may define, include, and/or hold threads, tabs, latches, magnets, or any comparable attachment mechanism to removably attach the base coupler 235 to the motor shaft 243. Similarly, the motor shaft 243 may include a corresponding connector 246 to facilitate attachment with the base coupler 235 via the receptacle 241. The connector 246 may be a male coupler. The connector 246 may define, include, and/or hold threads, tabs, latches, magnets, or any equivalent corresponding attachment mechanism to removably attach the base coupler 235 to the motor shaft 243. In alternative embodiments, the receptacle 241 (FIG. 3B) may be a male coupler and the connector 246 may be a female coupler.

The blade shaft coupler 231 may be operatively coupled to the blade assembly 230 such that a rotation of the blade shaft coupler 231 imparts rotation on the blade assembly 230. In embodiments, the blade assembly 230 and the blade shaft coupler 231 may be permanently coupled to one another. In other embodiments, the blade assembly 230 and the blade shaft coupler 231 may be removably coupled. The blade assembly 230 may be positioned above the blade shaft coupler 231 along the vertical axis (e.g., the +Y/−Y axis of the coordinate axes of FIG. 2), such that the blade shaft coupler 231 is maintained between the blade assembly 230 and a base coupler 235. Additionally, the blade shaft coupler 231 may also include a cylindrical shaft 233 extending away from the blade shaft coupler 231 along the vertical axis (e.g., the +Y/−Y axis of the coordinate axes of FIG. 2). The cylindrical shaft 233 may contain splines 236 positioned on an exterior wall of the cylindrical shaft 233. The splines 236 may alternatively comprise ridges, tabs, threads, or any other equivalent attachment mechanism. In embodiments, the blade assembly 230 may be disposed within a mixing container 20 (FIG. 1) such that the blade assembly 230 is positioned on an interior side of the second section 28 (FIG. 1) of the mixing container 20 (FIG. 1) and the blade shaft coupler extends downward, along the vertical axis (e.g., the +Y/−Y axis of the coordinate axes of FIG. 2), to an exterior side of the second section 28 (FIG. 1) of the mixing container 20 (FIG. 1). The blade shaft coupler 231 may operatively couple with the base coupler 235, such that the blade shaft coupler 231 and the base coupler 235 are interlocked so that the motor may impart a rotation to the motor shaft 243 and the base coupler 235, which in turn operatively induces a rotation of the blade shaft coupler 231 and the blade assembly 230. Collectively, the motor, the motor shaft 243, the base coupler 235, the blade shaft coupler 231, and the blade assembly 230 make up a drive chain that enables the motor of the blender base 40 (FIG. 1) to operatively drive the blade assembly 230 via the respective connections of each element in the drive chain. In embodiments, the blade shaft coupler 231 may directly couple with the base coupler 235. In further embodiments, the cylindrical shaft 233 and the splines 236 may couple the blade shaft coupler 231 to the base coupler 235. The blade shaft coupler 231 and the base coupler 235 may be removably coupled to allow separation of the mixing container 20 (FIG. 1) from the blender base 40 (FIG. 1) to permit, cleaning, repair, or the like. In alternative embodiments, the blade shaft coupler 231 may include a female coupler and the base coupler 235 may include a male coupler to operatively couple the blade shaft coupler 231 and the base coupler 235.

Still referring to FIG. 2, the connector 246 of the motor shaft 243 may include a tapered segment. In embodiments, the connector 246 of the motor shaft 243 may include a tapered segments such that the connector 246 has a tapered profile such that the connector 246 has a conical shape with a greater radius at its first end and has a smaller radius at its second end, wherein the second end is positioned proximate to the base coupler 235 and above the first end, along the vertical axis (e.g., the +Y/−Y axis of the coordinate axes of FIG. 2). The base coupler 235 may define a corresponding receptacle 241 (FIG. 3B) with a tapered profile to accept the tapered profile of the connector 246. The receptacle 241 may be disposed within the center of the second side 206 of the base coupler 235 to allow the base coupler 235 to operatively connect to the motor shaft 243. In embodiments, the base coupler 235 and motor shaft 243 may rotate together and the respective tapered profiles of the base coupler 235 and motor shaft 244 bias the center of mass of each component toward a common axis of rotation, allowing the base coupler 235 to self-center or otherwise correct radial misalignment of the base coupler 235 relative to the motor shaft 243 (e.g. misalignment of the respective axes of rotation of the base coupler 235 and the motor shaft 243). This self-centering feature can produce less decentering between the base coupler 235 and the motor shaft 243 when coupled, reducing gnashing, providing for easier manufacturability, and minimizing vibration resulting in reduced noise.

Now referring jointly to FIGS. 2 and 3A-3B, the coupling unit 200 may include a base coupler 235 having a first portion 251 and a second portion 253. The first portion 251 and the second portion 253 may form the exterior walls of the base coupler 235. The first portion 251 may be positioned in contact with and above the second portion 253, along the vertical axis (e.g., the +Y/−Y axis of the coordinate axes of FIG. 2). In embodiments, the first portion 251 includes the first side 203 positioned at an upper end of the first portion 251 along the vertical axis (e.g., the +Y/−Y axis of the coordinate axes of FIG. 2), proximate to the blade shaft coupler 231. The second portion 253 includes a second side 206 positioned at the lower end of the second portion 253 along the vertical axis (e.g., the +Y/−Y axis of the coordinate axes of FIG. 2), proximate to the motor shaft 243. The second portion 253 may have a columnar profile, whereas the first portion 251 may have a tapered profile such that the first portion 251 has an overall conical shape with a larger radius near the second portion 253 and a smaller radius near the first side 203.

Additionally, the coupling unit 200 may also include a blade shaft coupler 231 that may be positioned within and additionally may surround the base coupler 235, wherein the blade shaft coupler 231 and the base coupler 235 interlock such that the blade shaft coupler 231 and the base coupler 235 rotate in unison. In embodiments, the blade shaft coupler 231 has a columnar exterior wall with a uniform diameter. The blade shaft coupler 231 may include a recess 257 defined within the blade shaft coupler's exterior wall that can accept the base coupler 235. In embodiments, the blade shaft coupler also includes a tapered skirt 255 defining the perimeter of the recess 257. The tapered skirt 255 may be shaped to receive the first portion 251 and may have a corresponding tapered profile so the slope of the tapered skirt 255 matches the slope of the tapered first portion 251. When the tapered first portion 251 is received within the recess 257 and fits against the tapered skirt 255, the base coupler 235 and the blade shaft coupler 231 may interface and rotate together. The tapered or conical interface may reduce or eliminate the rotational decentering between the blade shaft coupler 231 and the base coupler 235. The interaction of the tapered first portion 251 and tapered skirt 255 during rotation may bias the center of mass of each component toward a common axis of rotation, allowing the blade shaft coupler 231 to self-center or otherwise correct radial misalignment of the blade shaft coupler 231 relative to the base coupler 235 (e.g. misalignment of the respective axes of rotation of the base coupler 235 and the blade shaft coupler 231). This self-centering aspect can minimize or eliminate radial misalignment of the drive chain, provide for easier manufacturability, and minimize vibration resulting in reduced noise. By matching the angle or slope of the base coupler 235 and the blade shaft coupler 231, the concentricity of the conical interface to the rotational axis is controlled. If these two aspects are achieved, then parts can couple while minimizing radial misalignment and decentering during operation.

Referring now specifically to FIGS. 3A and 3B, the coupling unit 200 may include a base coupler 235 that has a drive socket 239 to directly interact with a cylindrical shaft 233 of the blade shaft coupler 231. The cylindrical shaft 233 of the blade shaft coupler 231 may be positioned in the center of the recess 257, extending downward from the top of the blade shaft coupler 231, along the vertical axis (e.g., the +Y/−Y axis of the coordinate axes of FIG. 2). The drive socket 239 may be disposed within the center of the first side 203 of the first portion 251. In embodiments, the drive socket 239 has a diameter corresponding to the diameter of the cylindrical shaft 233 such that drive socket 239 includes a concentric inner wall that corresponds or has substantially the same angle as a concentric exterior wall of the cylindrical shaft 233. Furthermore, the drive socket 239 extends downward along the vertical axis (e.g., the +Y/−Y axis of the coordinate axes of FIG. 2) from the first side 203 to a depth corresponding to the length of the cylindrical shaft 233. The cylindrical shaft 233 may be positioned within the drive socket 239 when the base coupler 235 and blade shaft coupler 231 interface, such that the cylindrical shaft 233 may interlock with the drive socket 239 and rotate in unison during operation of the blender system. The cylindrical shaft 233 may include first splines 236 and the drive socket 239 may include second splines 237 to interact with the first splines 236 of the cylindrical shaft 233. In so doing, the base coupler 235 and the blade shaft coupler 231 may interlock via the first splines 236 and second splines 237 such that the base coupler 235 and the blade shaft coupler 231 are drivingly engaged, wherein torque imparted on the base coupler 235 by the motor shaft 243 is transferred to the blade shaft coupler 231 due to the interaction of the first splines 236 and second splines 237. In embodiments, the first splines 236 may be a first set of splines positioned along the concentric exterior wall of the cylindrical shaft 233 and a second set of splines 237, corresponding to the number, shape, and orientation of the first set of splines 236, positioned on the concentric inner wall of the drive socket 239. In embodiments, the first splines 236 and the second splines 237 may be parallel splines, helical splines, or threads.

Referring collectively now to FIGS. 3A-3B, 4A-4B, and 5A-5B, the coupling unit 200 may include a down-force element. As discussed herein, it may be beneficial to maintain clearance between coupling components when the blender system 100 (FIG. 1) is at rest to enable coupling between the blade shaft coupler 231 attached to the mixing container 20 (FIG. 1) and the base coupler 235 attached to the blender base 40. However, during operation of the blender system 100 (FIG. 1), it is beneficial to minimize clearance between the blade shaft coupler 231 and the base coupler 235 to prevent openings or gaps between the interfacing portions of the blade shaft coupler 231 and the base coupler 235 that would enable rattling or vibration of one or more parts of the coupling unit 200 and subsequent noise production. Accordingly, the down-force element of the coupling unit 200 can impart a downward force or down-force to the blade shaft coupler 231, along the vertical axis (e.g., the +Y/−Y axis of the coordinate axes of FIG. 2). The down-force element may cause the base coupler 235 and the blade shaft coupler 231 to interface such that the distance between the base coupler 235 and the blade shaft coupler 231 is eliminated or minimized. In embodiments, the down-force element may minimize clearance between specific parts of the base coupler 235 and the blade shaft coupler 231. For instance, the down-force element may apply a down-force to the blade shaft coupler 231 so as to maximize interaction between the tapered skirt 255 and the first portion 251 and minimize clearance between the base coupler 235 and the blade shaft coupler 231. Additionally, the down-force element may apply a down-force to the blade shaft coupler 231 so as to maximize interaction between the cylindrical shaft 233 and the drive socket 239 and minimize clearance between the cylindrical shaft 233 and the drive socket 239. As used herein, any or all of: the tapered skirt 255, the first portion 251, the cylindrical shaft 233, and the drive socket 239 may be referred to as the interfacing portions or interacting portions of the blade shaft coupler 231 and the base coupler 235.

In embodiments, the coupling unit 200 may include a single type of down-force element. The down-force element may be any one of helical splines, snap-fit connectors, magnets, electro magnets, moveable masses, or any equivalent design intended to apply an external downward force, along the vertical axis (e.g., the +Y/−Y axis of the coordinate axes of FIG. 2), to the blade shaft coupler 231 to minimize clearance and maintain interaction with the base coupler 235. The coupling unit 200 may include a single down-force element. In other embodiments, the coupling unit 200 may include two or more down-force elements of the same type. Additionally, the coupling unit 200 may include two or more different types of down-force elements. In an exemplary embodiment, the coupling unit 200 may include helical splines and snap-fit connectors as down-force elements that collectively apply a down-force to the blade shaft coupler 231.

Additionally, the one or more down-force elements may work in conjunction with the tapered design of the coupling unit 200. While the interaction of the tapered first portion 251 and the tapered skirt 255 may prevent radial misalignment (e.g. misalignment of the respective axes of rotation of the base coupler 235 and the blade shaft coupler 231), the effect of the self-centering behavior of the coupling unit 200 may be enhanced by inclusion of one or more down-force elements. The self-centering arrangement of the tapered first portion 251 and the tapered skirt 255 may prevent unwanted radial misalignment along the horizontal axes (e.g., the +X/−X or Z axes of the coordinate axes of FIG. 2), while the down-force element may prevent clearance along the vertical axis (e.g., the +Y/−Y axis of the coordinate axes of FIG. 2). In embodiments, application of a down-force by the down-force element may minimize clearance along the vertical axis (e.g., the +Y/−Y axis of the coordinate axes of FIG. 2) between the blade shaft coupler 231 and the base coupler 235, thereby reducing movement of the blade shaft coupler 231 in relation to the base coupler 235, limiting the potential for radial misalignment or decentering along a horizontal axes (e.g., the +X/−X or Z axes of the coordinate axes of FIG. 2). In so doing, the tapered first portion 251 and the tapered skirt 255 need only make minor corrections to radial misalignment about the motor shaft 243 (FIG. 2). Similarly, the self-centering corrections of the coupling unit 200, due to the tapered first portion 251 and the tapered skirt 255, may minimize radial misalignment, thereby reducing movement of the blade shaft coupler 231 in relation to the base coupler 235, limiting the potential for the creation of vertical clearance along the vertical axis (e.g., the +Y/−Y axis of the coordinate axes of FIG. 2). In so doing, the down-force element need only make minor corrections to vertical clearance between the interacting portions of the blade shaft coupler 231 and the base coupler 235.

Referring again to FIGS. 3A and 3B, in an embodiment, the one or more down-force elements may be a first set of splines 236 extending from an exterior wall of the cylindrical shaft 233 and a second set of splines 237 extending from an interior wall of the drive socket 239. The splines 236 may include a first set of splines 236 positioned on the cylindrical shaft 233 and a second set of splines 237, corresponding to the number, shape, and orientation of the first set of splines 236, positioned within the drive socket 239. In embodiments, the splines 236, 237 may be helical or form continuous helical threads. The helical arrangement and coupling of the first splines 236 and second splines 237 causes the base coupler 235 and the blade shaft coupler 231 to operatively rotate together due to the torque imparted by the motor shaft 243 (FIG. 2). In so doing, the interaction and rotation of the first splines 236 and the second splines 237 causes the base coupler 235 to pull the blade shaft coupler 231 downwards along the vertical axis (e.g., the +Y/−Y axis of the coordinate axes of FIG. 2), creating a down-force that minimizes clearance between the interacting portions of the blade shaft coupler 231 and the base coupler 235. In embodiments, the first splines 236 may turn clockwise or counter-clockwise according to the orientation of the second splines splines 237, to impart a downward force along the vertical axis (e.g., the +Y/−Y axis of the coordinate axes of FIG. 2) on the blade shaft coupler 231.

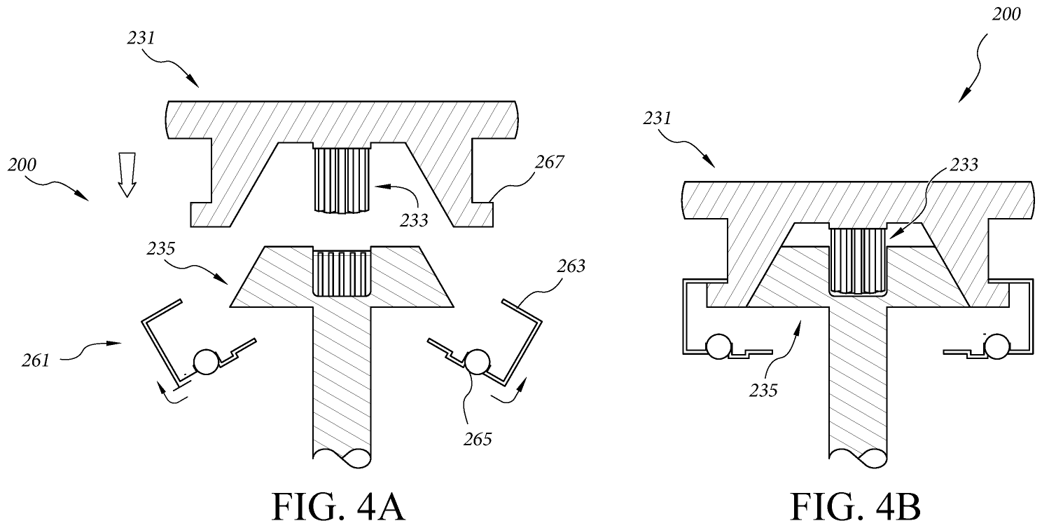

Referring now to FIGS. 4A and 4B, the coupling unit 200 may include one or more down-force elements. In embodiments, the one or more down-force elements may be snap-fit connectors 261. Each snap-fit connectors 261 further includes a proximate end 265 and a distal end 263. In embodiments, the proximate end 265 is fixed to a pivot point on the base coupler 235 so that snap-fit connector 261 may operatively rotate with the coupling unit 200. Alternatively, the proximate end 265 may be fixed to a pivot point on a stationary portion of the blender base 40 (FIG. 1) and may exert a down-force on the base coupler 235 while permitting the base coupler 235 to rotate freely. The distal end 263 of the snap-fit connector 261 is moveable relative to the base coupler 235 so that the distal end 263 can rotate about the pivot point and surround a lip 267 of the blade shaft coupler 231. The snap-fit connector 261 may exert a clamping force wherein the distal end 263 may wrap around or surround the lip 267 and maintain a down-force on the blade shaft coupler 231 to reduce clearance between the base coupler 235 and the blade shaft coupler 231. In embodiments, the coupling unit 200 may include two snap-fit connectors 261 positioned opposite one another on either side of the coupling unit 200.

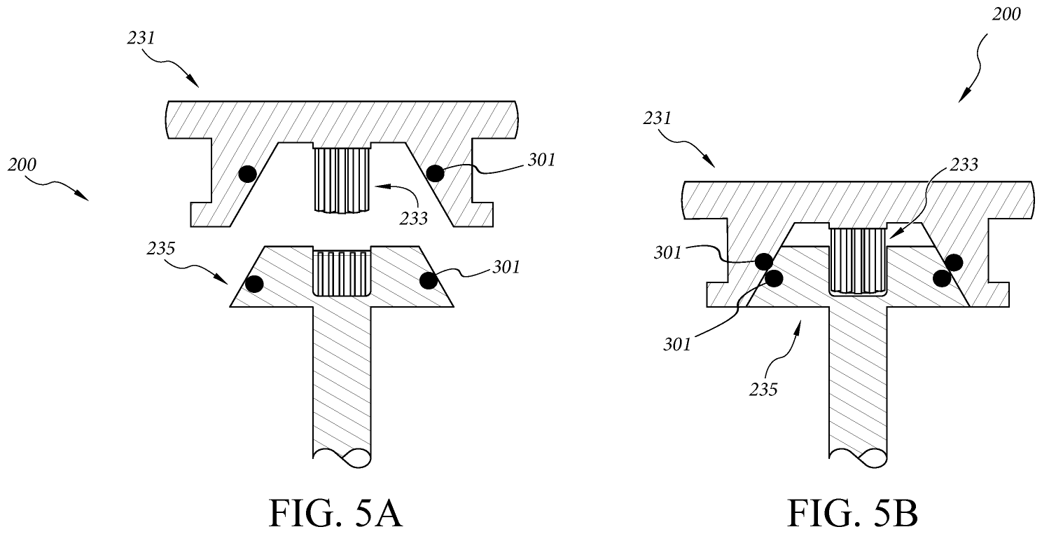

Referring now to FIGS. 5A and 5B, the coupling unit 200 may include one or more down-force elements. In embodiments, the one or more down force elements may be magnets 301. In embodiments, the one or more magnets 301 may be positioned between the base coupler 235 and the blade shaft coupler 231 such that at least one magnet 301 is positioned on the blade shaft coupler 231 and at least one magnet 301 is positioned on the base coupler 235 to correspond with the position of the magnet 301 positioned on the blade shaft coupler 231. This arrangement allows for the blade shaft coupler 231 to interface with the base coupler 235 and the at least one magnet 301 positioned on the blade shaft coupler 231 may interact with the at least one magnet 301 positioned on the base coupler 235, creating a magnetic field between the magnets 301 and applying a downward force to the blade shaft coupler 231 to keep the blade shaft coupler 231 seated and thereby reduce clearance between the interacting portions of the coupling unit 200. In other embodiments, the one or more magnets 301, may be electro magnets powered by a power supply of the blender system 100 (FIG. 1).

In further embodiments, the coupling unit 200 further includes one or more movable masses integrated with the blade shaft coupler 231. The moveable masses may be positioned on or disposed within an internal cavity of the blade shaft coupler 231. The moveable masses may be one of ball bearings, a roller on a track, or fixed weights. As the coupling unit 200 rotates, the movable masses may move outward along the horizontal axes (e.g., the +X/−X or Z axes of the coordinate axes of FIG. 2) and/or upward along the vertical axis (e.g., the +Y/−Y axis of the coordinate axes of FIG. 2) due to centripetal force from the rotation imparted by the motor shaft 243. In embodiments, the one or more movable masses develop a combination of lateral and vertical forces as a result of the rotation of the coupling unit 200. The movable masses may function to create both a down-force along the vertical axis (e.g., the +Y/−Y axis of the coordinate axes of FIG. 2) and correct of radial misalignment along the horizontal axes (e.g., the +X/−X or Z axes of the coordinate axes of FIG. 2). The centripetal forces acting on the movable masses create a net down-force, seating the blade shaft coupler 231 within the base coupler 235. Furthermore, the rotation of the movable masses about the motor shaft 243 may also serve to correct any decentering of the blade shaft coupler 231 or the base coupler 235. The centripetal forces acting on the movable masses may create a self-centering tendency of the blade shaft coupler 231 acting in conjunction with the tapered first portion 251 and the tapered skirt 255 to align rotational axes of the base coupler 235 and the blade shaft coupler 231 and correct radial misalignment.

It should now be understood that the present disclosure provides for blender systems and coupling units that may permit the attachment of a mixing container to a blender base. The coupling unit of the blender system includes a tapered base coupler that may be removably coupled to a correspondingly tapered blade shaft coupler. The tapered, conical profiles of the base coupler and the blade shaft coupler permit the components of the drive chain to self-center and correct for radial misalignment. Additionally, blender system and coupling unit may include one or more down-force elements that may minimize the clearance distance between the interacting portions of the blade shaft coupler and the base coupler to reduce vibration and subsequent noise caused by the components of drive chain. The down-force element may include first and second helical splines positioned on the base coupler and blade shaft coupler respectively, to interlock and induce a downward force on the blade shaft coupler during rotation. Additionally, the down-force element may include one or more snap-fit connectors to directly apply a down force to the blade shaft coupler. Furthermore, the down-force element may include magnets or electro magnets positioned on or within the blade shaft coupler and the base coupler to induce a magnetic field to minimize clearance between the interacting portions of base coupler and blade shaft coupler. Accordingly, the present disclosure provides for blender systems with efficient coupling and removal that can minimize vibration due to clearance space between coupling components and can minimize rotational decentering and radial misalignment of drive chain components.

It may be noted that one or more of the following claims utilize the terms “where,” “wherein,” or “in which” as transitional phrases. For the purposes of defining the present technology, it may be noted that these terms are introduced in the claims as an open-ended transitional phrase that are used to introduce a recitation of a series of characteristics of the structure and should be interpreted in like manner as the more commonly used open-ended preamble term “comprising.”

Having described the subject matter of the present disclosure in detail and by reference to specific embodiments, it may be noted that the various details described in this disclosure should not be taken to imply that these details relate to elements that are components of the various embodiments described in this disclosure, even in casings where a particular element may be illustrated in each of the drawings that accompany the present description. Rather, the claims appended hereto should be taken as the sole representation of the breadth of the present disclosure and the corresponding scope of the various embodiments described in this disclosure. Further, it will be apparent that modifications and variations are possible without departing from the scope of the appended claims.

1. A blender system, comprising:
a blade assembly;
a blender base containing a motor and a motor shaft operatively coupled to the motor; and
a coupling unit, the coupling unit further comprising:
a base coupler operatively coupled to the motor shaft and extending from the blender base;
a blade shaft coupler coupled to the blade assembly; and
a down-force element,
wherein the down-force element exerts a downward force on the blade shaft coupler to minimize a clearance between the base coupler and the blade shaft coupler during operation.

2. The blender system of claim 1, wherein the coupling unit comprises two or more down-force elements.

3. The blender system of claim 1, wherein the base coupler defines a cylindrical drive socket disposed in a center of the base coupler and the blade shaft coupler further comprises a cylindrical shaft positioned in the center of the blade shaft coupler, such that the cylindrical shaft operatively fits within the cylindrical drive socket when the base coupler and blade shaft coupler interface.

4. The blender system of claim 3, wherein the down-force element comprises first splines positioned on the cylindrical shaft and second splines positioned on a wall of the cylindrical drive socket.

5. The blender system of claim 4, wherein the first splines and the second splines each comprise helical splines.

6. The blender system of claim 1, wherein the down-force element comprises one or more snap-fit connectors, the one or more snap-fit connectors comprising a proximate end and a distal end, wherein the proximate end is coupled to the base coupler and the distal end is moveable relative to the base coupler such that the distal end can surround a lip of the blade shaft coupler and reduce clearance between the base coupler and the blade shaft coupler.

7. The blender system of claim 6, wherein the down-force element comprises two snap-fit connectors positioned opposite one another on either side of the base coupler.

8. The blender system of claim 1, wherein the down-force element comprises one or more magnets positioned between the base coupler and the blade shaft coupler.

9. The blender system of claim 1, wherein the down-force element comprises one or more electro magnets positioned between the base coupler and the blade shaft coupler, wherein the one or more electro magnets are actuatable by a power supply of the blender system.

10. The blender system of claim 1, wherein the coupling unit further comprises one or more movable masses integrated with the blade shaft coupler.

11. The blender system of claim 10, wherein the one or more movable masses comprise one of ball bearings, a roller on a track, or fixed weights.

12. A coupling unit comprising:
a base coupler having a tapered first portion and a bottom portion operatively coupled to a motor shaft; and
a blade shaft coupler operatively coupled to a blade assembly and comprising a conical recess having a corresponding tapered skirt shaped to receive the tapered first portion of the base coupler such that the base coupler and the blade shaft coupler interface and rotate together.

13. The coupling unit of claim 12, wherein the base coupler defines a cylindrical drive socket disposed in a center of the tapered first portion and the blade shaft coupler further comprises a cylindrical shaft positioned in the center of the blade shaft coupler such that the cylindrical shaft operatively fits within the cylindrical drive socket when the base coupler and blade shaft coupler interface.

14. The coupling unit of claim 13, wherein the blade shaft coupler further comprises first helical splines positioned on the cylindrical shaft and the base coupler further comprises second helical splines positioned on a wall of the cylindrical drive socket.

15. The coupling unit of claim 12, wherein the motor shaft further comprises a tapered connector and the base coupler defines a corresponding tapered receptacle disposed within a center of the bottom portion of the base coupler such that the base coupler and the motor shaft interface with each other to rotate together.

16. The coupling unit of claim 12, wherein the coupling unit further comprises one or more snap-fit connectors, the one or more snap-fit connectors comprising a proximate end and a distal end, wherein the proximate end is coupled to the base coupler and the distal end is moveable relative to the base coupler such that the distal end surrounds a lip of the blade shaft coupler and reduces clearance between the base coupler and the blade shaft coupler.

17. The coupling unit of claim 12, wherein the coupling unit further comprises one or more magnets positioned between the base coupler and the blade shaft coupler.

18. The coupling unit of claim 12, wherein the coupling unit further comprises one or more electromagnets positioned between the base coupler and the blade shaft coupler, wherein the one or more electromagnets are actuable by a power supply.

19. The coupling unit of claim 12, wherein the coupling unit further comprises one or more movable masses integrated with the blade shaft coupler.

20. The coupling unit of claim 19, wherein the one or more movable masses comprise one of ball bearings, a roller on a track, or fixed weights.
